(19) United States
(12) Patent Application Publication
(10) Pub. No.: US 2020/0189887 A1
(43) Pub. Date: Jun. 18, 2020

(54) Rail-Based Floor Conveyor System

(71) Applicant: Strothmann Machines & Handling GmbH, Schloss Holte-Stukenbrock (DE)

(72) Inventor: Tim Büllesbach, Werther (DE)

(21) Appl. No.: 16/686,506

(22) Filed: Nov. 18, 2019

(30) Foreign Application Priority Data
Dec. 13, 2018 (DE) 102018009914.9

(51) Int. Cl. B66C 7/08; B65G 21/22; E01B 5/04; F16C 19/34; F16C 29/04

(52) U.S. Cl. CPC B66C 7/08; B65G 21/22; F16C 29/045; F16C 19/34; E01B 5/04

(57) ABSTRACT

A rail-based floor conveyor system, with a floor conveyor with concavely grooved wheels and rails having a surface which, when in contact, dips at least partially into the grooved area of the wheels, thereby producing at least two load-bearing lines during the movement of the floor conveyor, wherein a wheel holder is provided for each wheel, with at least one horizontal axis of rotation for each wheel and a vertical axis of rotation to a bearing connected to the floor conveyor, and wherein the wheels can be moved by drives or manually on the rail, bearing including a first bearing part and a second bearing part, wherein one of the bearing parts has a concave surface section, which is at least partially in contact with a convex surface section of the respective other bearing part, and wherein both bearing parts are movable relative to one another while maintaining contact.

The invention relates to a rail-based floor conveyor system, with at least one floor conveyor with concavely grooved wheels in the region of the circumference, as well as rails having a surface which, when in contact, dip at least partially into the grooved region of the wheels, thereby producing at least two load-bearing lines during movement of the floor conveyor, wherein a wheel holder is provided for each wheel or pair of wheels, with at least one horizontal axis of rotation for each wheel and a vertical axis of rotation to a bearing connected to the floor conveyor, and wherein the wheels can be moved by drives or manually on the rail.

The rails (pairs), mentioned here, are primarily, but not limited to, the rails marketed by the Applicant in accordance with DE 4318383 C1 or WO 2014/032699 A1, that is rails with a convex surface. This type of round rail has proven itself in practice, because such rails are of simple construction and thus manufactured easily. In addition, a rail-based floor conveyor with concave wheel bearing surfaces between the wheel flanks can be guided safely over the round profile. A further advantage for factory buildings is that the rail can be laid almost flush with the floor, so that the freedom of movement of other vehicles is not restricted. In contrast to U-shaped rails, on which the wheels of the floor conveyor run, the risk of contaminating the rails is reduced significantly.

Such a rail-wheel representation of the introductory portion is shown on page 3, of the latest brochure, “Rundschienen-Systeme”; of the Applicant of March 2018. Two edges of the wheel, which are aligned in the rolling direction at an angle to the vertical or horizontal plane, then run on the cylindrical surface of the rail. The advantages of these round rails lie in their tracking stability, since the wheel is guided stably on the rail by the two stabilizing edges, and in the minimum resistance, which prevails during a rolling motion due to the geometry of the contact surface between the rail and the wheel. In other words, the rolling movement of a wheel on the round rail takes place with a low input of energy even under relatively large loads. Both annular load-bearing lines in the case of contact with the rail extend within the concavely grooved portion of the wheel.

The linear contact is chosen so that the surface pressure and the rolling resistance are in a favorable ratio to one another.

In the brochure, for example, turntables are also found, on which a floor conveyor with all wheels is located and can be turned in a go-ahead direction. Switches, named “four-way switches”, are also known from the brochure. These are smaller, mounted turntables with cross-shaped recessed guides for the wheels of the floor conveyor. The diameter of the turntable is so large, that one wheel or a pair of wheels can fit on it. Accordingly, only those wheels necessary for this purpose are rotated about the vertical axis and forwarded on the intersecting rails for the intended change in direction of the floor conveyor. With that, the floor conveyor is moved transversely to its original direction of travel. These switches may be self-powered or passive and rotated only by initiation of the rotation of the carriage wheels. An exact positioning of the switches in the space and also relative to one another is of essential importance for the wheel bases of the floor conveyor.

These rail-based floor conveyor systems used have proven to be particularly effective and reliable in the rail system.

However, it does happen that the rails of a pair of rails do not extend 100% exactly parallel to one another. If deviations in the track width between the round rail wheels and the round rails cannot be compensated for, one edge of the round rail wheel will run onto the round rail or at least put a higher stress on it.

A rotation of the round rail wheel relative to the round rail about the vertical axis of the round rail wheel also leads to a reduction in the benefits, as this shifts the support lines between the round rail wheel and the round rail on the round rail, thus, for instance, increasing the friction when rolling.

Or very high loads on the floor conveyor carriages may cause the vertical axes of rotation of the wheels to be no longer entirely 100% parallel to one another. As a result, one of the edges of the wheel groove is placed under a greater load.

In addition, of course, there may also be a fluctuation or inaccuracy in the orientation of the round rail itself, that is, a variance or lack of constancy in the track.

Previous solutions to compensate for track variance, deformation of the carriage or lack of constancy in the track are the
Ensuring of axial play in the mounting of the round rail wheel to compensate for track variances and
Suspending the wheel suspension in the area of the bearing by means of a deformable body made of an elastomer.

However, both modes of operation have disadvantages in their arrangement. For instance, axial play is unfavorable for applications with a high positioning accuracy or for forces acting transversely to the direction of travel of the round rail carriage. When an elastomer is used to suspend the round rail wheel to compensate for the effects, the elastomer must first of all be deformed, which leads to an increase in the transverse force at the round rail wheel and/or a restoring moment about the vertical axis of the round rail wheel.

It is therefore an object of the invention to develop a rail-based floor conveyor system, in which there is compensation for the problems described with regard to track variance, the deformation of the carriage or the lack of constancy in the track.

The objective is accomplished in accordance with the features of claim 1 and, in particular, owing to the fact that the bearing, which is connected with the floor conveyor, comprises at least a first bearing part and a second bearing part, wherein one of the bearing parts has a concave surface section, which is at least partially in contact with a convex surface section of the respectively other bearing part is and wherein the two bearing parts can be moved relative to one another while maintaining contact.

Accordingly, the two bearing parts can be rotated relative to one another at least about the vertical axis, so that the wheels can adapt to curved or not exactly parallel rail courses or can be used on the four-way switches described.

Advantageously, provisions are made so that the convex and concave surface sections of the first bearing part and the second bearing part are formed by circular arcs of the same radius.

If the surface sections have the same radii, they fit against one another over a large area. As a result, the pressure load or surface pressure is kept very low even with heavy loads on the floor conveyor in the area of the two bearing parts.

Preferably, the convex surface section of the first bearing part of at least one bearing can be swiveled in arc-shaped fashion on the concave surface section of the second bearing part transversely to the running direction of the rail.

Provisions are thus also made, at least in some of the bearings, that the bearing parts can be swiveled laterally, that is, transversely to the rail direction, relative to one another. This makes it very easily possible to compensate for track variances without increasing the load on an edge of the grooved region of the wheel impermissibly. Admittedly, the two annular load bearing lines at the wheel are shifted a little; however, this has hardly any impact on the load on the wheels and the rail.

Preferably, the bearing is a spherical bearing.

When the two bearing parts are joined together to form a spherical bearing, that is, have surfaces with a spherical surface—one a concave surface and the other a convex surface—swiveling degrees of freedom in all directions become possible.

Advantageously, provisions have been made so that the center of the circular arc of the concave and/or the convex surface section lies in the region of the rail.

In this way, it is achieved that, during the swiveling movement between the upper and the lower bearing parts, the wheel swivels along about the convex surface of the rail.

It is particularly preferred if the higher bearing part is provided with a concave surface section and the lower bearing part with a convex surface section.

In principle, the reverse arrangement would also be conceivable. However, as a result, any contamination in the contact area of the upper and lower bearing parts can be removed significantly better and almost automatically.

Advantageously, the higher bearing part is connected firmly to a supporting structure or a loading area of the floor conveyor.

By these means, the upper bearing part in the rail-based floor conveyor system is virtually fixed, while the lower bearing part can perform the rotational and/or swiveling movements. Accordingly, the lower bearing part is then connected to the wheel holder.

Alternatively, or optionally in addition to the ability to swivel relative to one another, it is preferred if at least one bearing means is provided to prevent swiveling, so that only a relative rotational movement of the wheel holder about the axis of rotation is feasible in the bearing.

It is thus possible to fix a bearing so that the wheels of a rail can only be rotated but not swiveled. If the rails are aligned precisely, the possibility is created of completely avoiding a change in the position of the loading area relative to the rail of the floor conveyor.

Moreover, it is advantageous if some bearings of the floor conveyor are provided with means for preventing the swiveling and others are not.

Such a means is useful essentially when the floor conveyor travels on two rails. This then means then that it is very advantageous if, for example, the wheels on only one side of the floor conveyor move at right angles to the rail if there is track variance. This increases the stability of the floor conveyor during movement.

Advantageously, at least one of the surface sections is provided with a layer, which reduces friction or consists of a different material than the respective other surface section, so that the coefficient of friction between the two surface sections is less than 0.1.

At a low coefficient of friction between the surface of the first bearing part and that of the second bearing part, the lateral load on the wheels can be minimized significantly.

At least one bearing preferably has an additional shock-absorbing elastomeric layer.

The change of wheels, for example, from the rails to a switch usually is associated with a very slight differences in height. This “height jump” may introduce impacts into the wheels, especially when the loads on the floor conveyor are heavy. The shock-absorbing layer reduces the intensity of the impacts and protects bearings, wheels and rails.

The invention will be explained in the following with reference to the illustrative drawings.

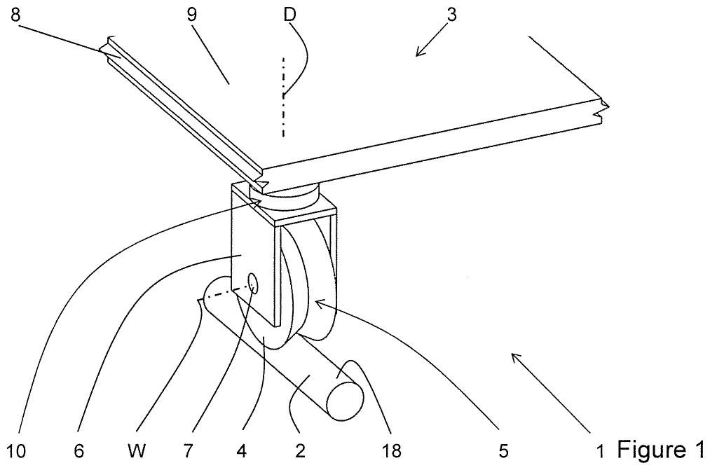

FIG. 1 shows a corner portion of a floor conveyor and a length of a rail in a basic construction

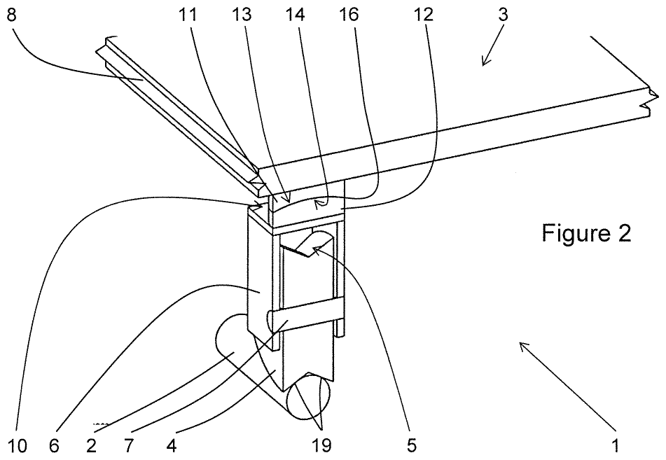

FIG. 2 shows a corner section of a floor conveyor and a section of rail with a central vertical section through the wheel

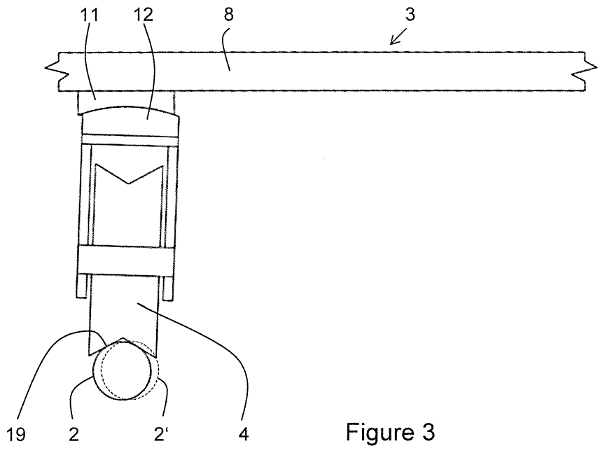

FIG. 3 shows the behavior of the inventive bearing when there is a lack of constancy in the rail track

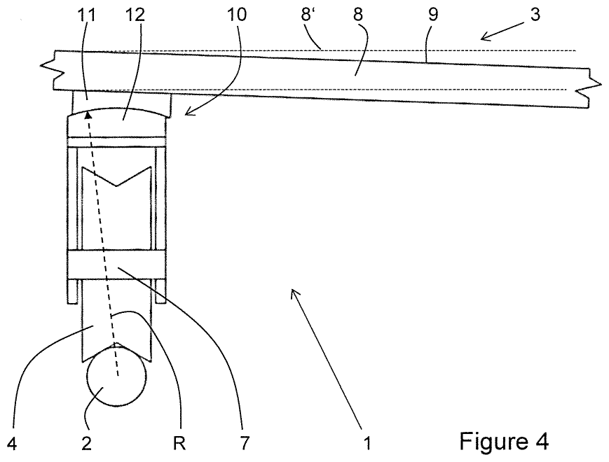

FIG. 4 shows the behavior of the inventive bearing when there is overloading of the loading area of the floor conveyor

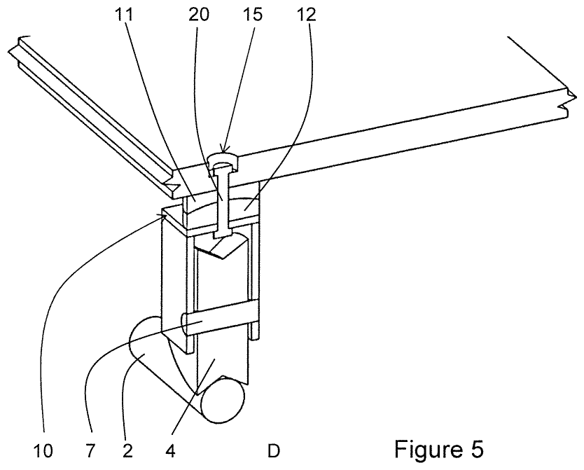

FIG. 5 shows a bearing with means to prevent swiveling

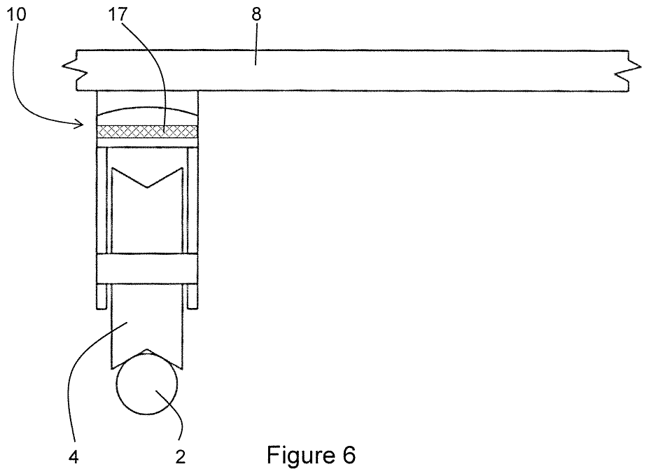

FIG. 6 shows a bearing with an additional elastomeric layer

A vertical section is shown in FIGS. 2 to 6 in order to be able to illustrate the features better. For reasons of clarity, cross-hatching was also dispensed with (except for the elastomeric layer).

FIG. 1 shows an embodiment of the basic structure of a rail-based floor conveyor system 1. In this case, only one corner of the floor conveyor 3 and a portion of a round rail 2 are shown. The floor conveyor 3 has a supporting construction 8, on which a loading area 9 is located.

In the embodiment, a bearing 10 is provided exactly at the corner of the support construction, in which a wheel holder 6 is mounted with at least one wheel about a vertical axis of rotation D. The wheel (there may also be several wheels) has a wheel axle 7, which also forms the horizontal axis of rotation W, about which the wheel may rotate.

FIG. 2 shows a vertical section through the bearing, the wheel and the rail of FIG. 1. It may be seen clearly that the bearing 10 is divided into a first bearing part 11 and a second bearing part 12. The first bearing part 11, which is disposed above the second bearing part 12, has a concave surface section 14, while the bearing part 12 has a convex surface section 13, which is adapted to the concave surface section 14 of bearing part 11. The two surface sections 13 and 14 abut one another, but still allow one or more degrees of freedom of movement relative between bearing parts 11, 12. At least the rotation of the wheel support to a vertical axis of rotation D should be preserved. Moreover, a slippery coating 16 may be provided on one or on both surface sections 13, 14. In some cases, it makes sense to design these surface sections 13, 14 as spherical surface sections, so that one is dealing with a spherical bearing. The possibility of swiveling movements relative to one another between the bearing parts 11, 12 is explained in more detail in the description of FIGS. 3 and 4.

However, with regard to FIG. 2, reference is still made to the effect of the grooving 5 of the wheel or of all wheels of the floor conveyor 3. The convex surface portion of the rail 2 dips into groove 5, so that there are two points of contact, which form a support perimeter 19 on the wheel 4, while the wheel is running around the wheel axle 7. They engage the rail 2 slightly laterally, so that the wheels are held securely in their track on the rail. The contact area is therefore minimal so as to reduce friction.

FIGS. 3 and 4 show how the two bearing parts 11 and 12 swivel relative to one another in certain situations.

In FIG. 3, the rail 2 does not run true to the track of the second rail for the floor conveyor 3, which is not shown. The correct position would be shown, for example, by the dashed line 2′. In this case, the bearing parts 11 and 12 swivel slightly towards each other, which has the positive consequence that the wheel does not run on one side of the rail and the burden of the one-sided load does not negatively affect the advantages of the invention. Due to the swiveling motion, the two peripheral contact lines in the groove region of the wheel are retained.

A similar case, in which swiveling between the first bearing part 11 and the second bearing part 12 is advantageous, is shown in FIG. 4, in which a deflection of the supporting structure 8 is brought about by a high load on the loading area 9. Here also, the normal position of the supporting structure is shown by a dashed line 8′. Thus, the bearing 10 can compensate for this deflection and, with that, avoid a lateral stress on the round rail 2. In this case, it is even possible to keep the wheel axle 7 horizontal. In both cases, that is, the ones shown in FIGS. 3 and 4, it is also seen that it makes sense if the center of the radius' R of the concave surface section of the upper bearing portion 11 and the center of the radius' R of the convex surface section of bearing part 12 lie in the region of the rail 2.

A special feature of the bearing 10 is shown in FIG. 5. In an advantageous embodiment, the bearing may be provided with means to prevent swiveling 15, in this embodiment in the form of a bolt 20 passing vertically through the first and the second parts of the bearing. If a bearing is provided with such means to prevent swiveling 15, this bearing can only allow a rotational movement of the wheel holder about a vertical axis of rotation D. With that, the stability of the floor conveyor can be increased significantly by allowing only one bearing on a rail to swivel, but preventing it on a second rail.

Finally, it should still be mentioned that—as shown by way of example in FIG. 6—elastomeric layers or components 17 may also be used in the bearing to avoid shocks and vibrations and thus to increase the life of the rail 2 or of the wheel 4.

### LIST OF REFERENCE SYMBOLS

1 Rail-based floor conveyor

2, 2′ Rail, round rail

3 Floor conveyor, carriage

4 Wheel

5 Wheel groove

6 Wheel holder

7 Wheel axle

8, 8′ Supporting construction

16 Slippery coating

17 Elastomeric coating

18 Convex rail surface

19 Contact point or peripheral line

20 Bolt

W Horizontal axis of rotation

D Vertical axis of rotation

R Radius

What is claimed is:

1. A rail-based floor conveyor system, comprising:
at least one floor conveyor with concavely grooved wheels around a circumference thereof and
rails having an outer surface which, when in contact with the wheels, dip at least partially into a grooved area of the wheels, thereby producing at least two load-bearing lines on the rails during movement of the floor conveyor,
a wheel holder for each wheel or pair of wheels, with at least one horizontal axis of rotation for each wheel and a vertical axis of rotation to a bearing which connects the wheel holder to the floor conveyor,
wherein the wheels are adapted to be moved by drives or manually on the rail, and
the bearing including at least a first bearing part and a second bearing part, one of the bearing parts having a concave surface portion which is at least partially in contact with a convex surface portion of the respective other bearing part, and wherein both bearing parts are movable relative to one another while maintaining contact.

2. The rail-based conveyor system of claim 1, wherein the convex and concave surface sections of the first and second bearing parts are formed by arcs of the same radius.

3. The rail-based conveyor system of claim 1, wherein the convex surface portion of a said bearing part of at least one said bearing is adapted to be swiveled in the direction of an arc transversely to the direction of the rail on the concave surface portion of the respective other bearing part.

4. The rail-based conveyor system of claim 1, wherein the bearing is a spherical bearing.

5. The rail-based conveyor system of claim 1, wherein centers of a circular arc of at least one of the concave surface portion and the convex surface portion lie in alignment with the rail.

6. The rail-based conveyor system of claim 1, wherein a higher one of the bearing parts is provided with said concave surface portion and a lower one of the bearing parts is provided with said convex surface portion.

7. The rail-based conveyor system of claim 6, wherein the higher bearing part is firmly connected with one of a supporting structure and a loading area of the floor conveyor.

8. The rail-based conveyor system of claim 1, further comprising an arrangement for preventing the swiveling at least at one bearing, so that only a relative rotational movement of the wheel holder about the vertical axis of rotation is feasible for the bearing.

9. The rail-based floor conveyor system of claim 8, wherein some bearings of the floor conveyor are provided with an arrangement for preventing swiveling and others are not.

10. The rail-based conveyor system of claim 1, wherein at least one of the surface portions is one of:
finished with a slippery coating or
includes a material different from that of the respective other surface portion, so that a coefficient of friction between the two surface portions is less than 0.1.

11. The rail-based conveyor system of claim 1, wherein at least one bearing has an additional shock-absorbing elastomeric layer.
